(19) United States
(12) Patent Application Publication
(10) Pub. No.: US 2014/0289115 A1
(43) Pub. Date: Sep. 25, 2014

(54) SYSTEMS AND METHODS FOR VEHICLE INFORMATION-BASED FUEL PURCHASING

(71) Applicant: AssetWorks Inc., Wayne, PA (US)

(72) Inventors: Joseph Angelo BASILE, Quakertown, PA (US); Debra A. HADLEY, Quakertown, PA (US)

(73) Assignee: AssetWorks Inc., Wayne, PA (US)

(21) Appl. No.: 14/107,590

(22) Filed: Dec. 16, 2013

Related U.S. Application Data
(60) Provisional application No. 61/804,859, filed on Mar. 25, 2013.

(51) Int. Cl. G06Q 20/40; G06Q 20/34; G06Q 20/24

(52) U.S. Cl. CPC G06Q 20/409; G06Q 20/24; G06Q 20/34
USPC 705/44

(57) ABSTRACT

A method for facilitating the purchase of fuel from a fuel pump, by a driver using a credit instrument to make a request for fuel, for a vehicle forming part of a fleet of vehicles owned by a fleet owner having fleet management software, comprising causing the driver to be prompted to submit vehicle information and driver information via the fuel pump, responsive to a credit request to purchase fuel for a vehicle using the credit instrument, ensuring the credit instrument has the required credit, confirming the vehicle information and the driver information, and if the ensuring and confirming are affirmed: authorizing the dispensing of fuel by the fuel pump; and if the ensuring or the confirming are denied: declining the dispensing of fuel by the fuel pump.

### CROSS-REFERENCE TO RELATED APPLICATIONS

This is a non-provisional of pending U.S. Provisional Patent Application Ser. No. 61/804,859, filed Mar. 25, 2013, the entirety of which application is expressly incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Typically fuel is one of the largest expenses an owner of a fleet of vehicles (referred to herein as Fleet Owners) may face. Owners of fleets of vehicles (referred to herein as Fleet Owners) often use various credit instruments to allow drivers of their vehicles to purchase fuel.

Due to its cost, it is desirable for Fleet Owners to control and monitor their fuel purchasing and consumption—for example based on rules relating to drivers, vehicle use, and the like.

At present, although monitoring can occur, there is considerable time lag between the purchasing of fuel and the availability to monitor the purchasing—and when available it is often in a different system than the system of record. Due to this time lag, there is reduced ability to control purchasing, especially in real-time. As such there is a need a simple and cost-effective way to enable mobile payments with realtime authorization and near realtime reporting.

### SUMMARY OF THE INVENTION

In one aspect there is a method for facilitating the purchase of fuel from a fuel pump, by a driver using a credit instrument to make a request for fuel, for a vehicle forming part of a fleet of vehicles owned by a fleet owner having fleet management software, comprising: causing the driver to be prompted to submit vehicle information and driver information via the fuel pump, responsive to a credit request to purchase fuel for a vehicle using the credit instrument, ensuring the credit instrument has the required credit, confirming the vehicle information and the driver information, and if the credit instrument has the required credit and the vehicle and driver information is confirmed: authorizing the dispensing of fuel by the fuel pump; if the credit instrument has insufficient credit or one or both of the vehicle information and the driver information cannot be confirmed: declining the dispensing of fuel by the fuel pump.

The vehicle information may comprise a vehicle identifier and an odometer value and the driver information may comprise a driver identifier.

The confirming may further comprise: checking whether one or more vehicle information fuel dispensing rules have been complied with, and ascertaining whether one or more driver information fuel dispensing rules have been complied with.

The vehicle information dispensing rules may comprise: is the odometer value for the vehicle sufficiently higher than an odometer reading at a last request for fuel for the vehicle or is the odometer value accurate, where the odometer value may be accurate if it is within an acceptable range of an odometer reading from the vehicle.

Confirming may further comprise receiving one or more of an odometer reading and the odometer reading at a last request for fuel for the vehicle.

The receiving may be from a fleet management software that is configured to communicate vehicle information with the vehicle and store the vehicle information.

The driver information dispensing rules may comprise: is the driver identifier authorized to fuel the vehicle, and is the driver identifier authorized to use the credit instrument.

The method may further comprise: if the ensuring and confirming are affirmed: obtaining, from the fuel pump, transaction information, and providing the transaction information to the fleet management software.

In another aspect there is a system for making a decision to dispense fuel from a fuel pump, responsive to a vehicle driver desiring to purchase fuel for a vehicle using a credit instrument owned by a vehicle owner, the system comprising a credit instrument, configured to cause a fuel pump to receive and communicate purchase parameters, and a first set of vehicle information, to a credit instrument issuer system, before seeking a credit decision and a fuel dispensing decision, and a credit instrument issuer system, configured to receive the purchase parameters and the first set of vehicle information from the fuel pump, make a credit decision and a fuel dispensing decision, provide the credit decision and the fuel dispensing decision to the fuel pump, and record a transaction information received from the fuel pump.

The credit instrument may be a credit card, the purchase parameters may include a date, a credit card number and a driver identifier of the vehicle driver and the first set of vehicle information comprises a vehicle number and a current odometer value from the vehicle.

The credit instrument issuer system may further comprises a rules storage, where the rules storage may be configured to store credit decision rules and fuel dispensing rules for the credit instrument and the fuel dispensing decision is affirmative if all credit decision rules and fuel dispensing rules are adhered to for the credit card.

The credit decision rules for the credit card may comprise: the vehicle driver is permitted to use the credit card, to purchase fuel for the vehicle, and the credit card has a balance that is below an acceptable balance.

The fuel dispensing rules for the credit card may comprise: the vehicle driver is permitted to use the credit card, to purchase fuel for the vehicle.

The system may further comprise a fleet owner configured to receive the transaction information from the credit instrument issuer system via a fleet management system. The fleet owner may be further configured to prevent unauthorized driver actions via the fleet management system.

In yet another aspect there is a method for facilitating the purchase of fuel from a fuel pump, by a driver using a credit instrument to make a request for fuel, for a vehicle forming part of a fleet of vehicles owned by a fleet owner, comprising: receiving, from a credit instrument issuer, vehicle information and driver information, obtained from a driver that was prompted to submit vehicle information and driver information via the fuel pump, responsive to a credit request to purchase fuel for a vehicle using the credit instrument, and confirming the vehicle information and the driver information, and if the confirming is affirmed: indicating, to the credit instrument issuer, the affirmation, and if the ensuring or the confirming are denied: indicating, to the credit instrument issuer, the denial.

The vehicle information may comprise a vehicle identifier and an odometer value and the driver information may comprise a driver identifier.

The confirming may further comprise: checking whether one or more vehicle information fuel dispensing rules have been complied with, and ascertaining whether one or more driver information fuel dispensing rules have been complied with.

The vehicle information dispensing rules may comprise: is the odometer value for the vehicle sufficiently higher than an odometer reading at a last request for fuel for the vehicle and/or is the odometer value accurate, where the odometer value is accurate if it is within an acceptable range of an odometer reading from the vehicle.

The driver information dispensing rules may comprise: is the driver identifier authorized to fuel the vehicle, and is the driver identifier authorized to use the credit instrument.

The method may further comprise: if the confirming is affirmed: receiving, from the credit instrument issuer, transaction information relating to the purchase of fuel from the fuel pump.

The fleet management system may be further configured to: if the confirming is affirmed: allowing a fleet owner to prevent unauthorized driver actions.

In yet a further aspect there is a system for facilitating the purchase of fuel from a fuel pump, by a driver using a credit instrument to make a request for fuel, for a vehicle forming part of a fleet of vehicles owned by a fleet owner, comprising: a fleet management system, configured for: receiving, from a credit instrument issuer, vehicle information and driver information, obtained from a driver that was prompted to submit vehicle information and driver information via the fuel pump, responsive to a credit request to purchase fuel for a vehicle using the credit instrument, and confirming the vehicle information and the driver information, and if the confirming is affirmed: indicating, to the credit instrument issuer, the affirmation, and if the ensuring or the confirming are denied: indicating, to the credit instrument issuer, the denial.

The vehicle information may comprise a vehicle identifier and an odometer value and the driver information comprises a driver identifier.

The confirming may further comprise: checking whether one or more vehicle information fuel dispensing rules have been complied with, and ascertaining whether one or more driver information fuel dispensing rules have been complied with.

The vehicle information dispensing rules comprise: is the odometer value for the vehicle sufficiently higher than an odometer reading at a last request for fuel for the vehicle and/or is the odometer value accurate, where the odometer value is accurate if it is within an acceptable range of an odometer reading from the vehicle.

The driver information dispensing rules may comprise: is the driver identifier authorized to fuel the vehicle, and is the driver identifier authorized to use the credit instrument.

The fleet management system may be further configured to: obtain, from a mobile data terminal on the vehicle, vehicle information, and store the obtained vehicle information.

The fleet management system may be further configured to: if the confirming is affirmed: receiving, from the credit instrument issuer, transaction information relating to the purchase of fuel from the fuel pump.

The fleet management system may be further configured to: if the confirming is affirmed: allowing a fleet owner to prevent unauthorized driver actions.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of a system for odometer-based fuel dispensing according to a non-limiting embodiment of the present invention;

FIG. 2 is a flowchart depicting a prior art method for fuel dispensing; and

FIG. 3 is a flowchart depicting a method for fuel dispensing according to a non-limiting embodiment of the present invention.

### DETAILED DESCRIPTION OF THE INVENTION

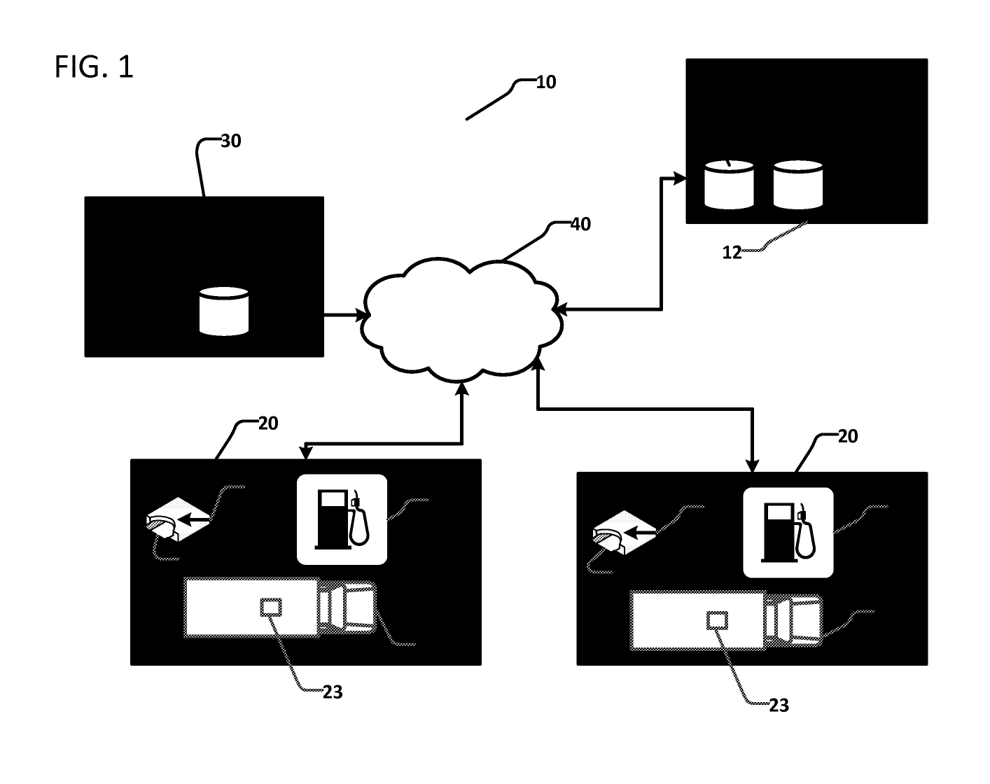

FIG. 1 is a diagram of a system 10 for odometer-based fuel dispensing according to a non-limiting embodiment of the present invention comprising credit instrument issuer 12 further comprising credit databases 14a/14b, one or more fuel dispensing locations 20 further comprising fuel pump 24 which may further comprise credit instrument reader 26, and credit instrument 28, and vehicle 22a/22b which may further comprise mobile data terminal (MDT) 23, communication network 40 and fleet owner 30, which may further comprise fleet management software 32.

Credit instrument issuer 12 may be any credit card issuer or other issuer of credit that may facilitate the purchase of fuel. Credit instrument issuer 12 may have many different systems, including computer systems, to perform approvals of credit-based transactions, and may also have one or more credit databases 14a/14b (that may also be, or include, rules storage) that may each relate to one or more credit instruments or owners of the credit instrument and store information about the vehicles, credit instruments, and transactions (including various transaction data) relating to the vehicles 22 and credit instruments 28. Credit instrument issuer 12 may be able to communicate with communication network 40.

Credit instrument 28 may be a credit card or the like, issued by credit instrument issuer 12, possibly in conjunction with another party, such as the owner of the fleet management software 32.

Fuel pump 24 may be substantially any system for dispensing fuel. Fuel pump 24 may further comprise credit instrument reader 26, which may accept credit instruments 28. Fuel pump 24 may dispense fuel if credit instrument 28 is accepted to use for purchasing fuel. Fuel pump 24 may be able to communicate with communication network 40.

Vehicle 22a/22b may be the vehicle that is intended to be filled with fuel from fuel pump 24. Vehicle 22a/22b may be substantially any type of vehicle (such as cars, buses, trucks, backhoes and the like) and may use substantially any type of fuel (gasoline, diesel, natural gas, and the like). Vehicle 22a and 22b may be owned by fleet owner 30; fleet owner 30 may own any number of vehicles 22.

Vehicle 22a/22b may further comprise mobile data terminal 23. MDT 23 may be any computing device that is on-board vehicle 22. MDT 23 may communicate with other systems of vehicle 22, such as odometers, sensors, engines, speedometers, passenger load or capacity counters, vehicle signs, or other systems. MDT 23 may be able to communicate with communication network 40 via, for example, an antenna (not shown) MDT 23 may further be configured to communicate with fleet management software (FMS) 32, for example to provide information about vehicle 22 to FMS 32.

Fleet owner 30 may own one or more vehicles for use in their operations. Fleet owners 30 may include rental car businesses, delivery businesses, retailers, and the like, substantially any company that owns vehicles.

Fleet owner 30 will have FMS 32 (FleetFocus) that assists in managing its fleet, and performing other functions. Exemplary fleet management software may include Asset Works' FleetFocus software. The maker of FMS 32 may be referred to as FMS Owner.

Communication network 40 may be any one or more communication networks, that may work together or independently, to facilitate communication of the various aspects of system 10. Communication network 40 may include cellular, WiFi, Bluetooth, wired, wireless, private, public, or any form of network or network technology.

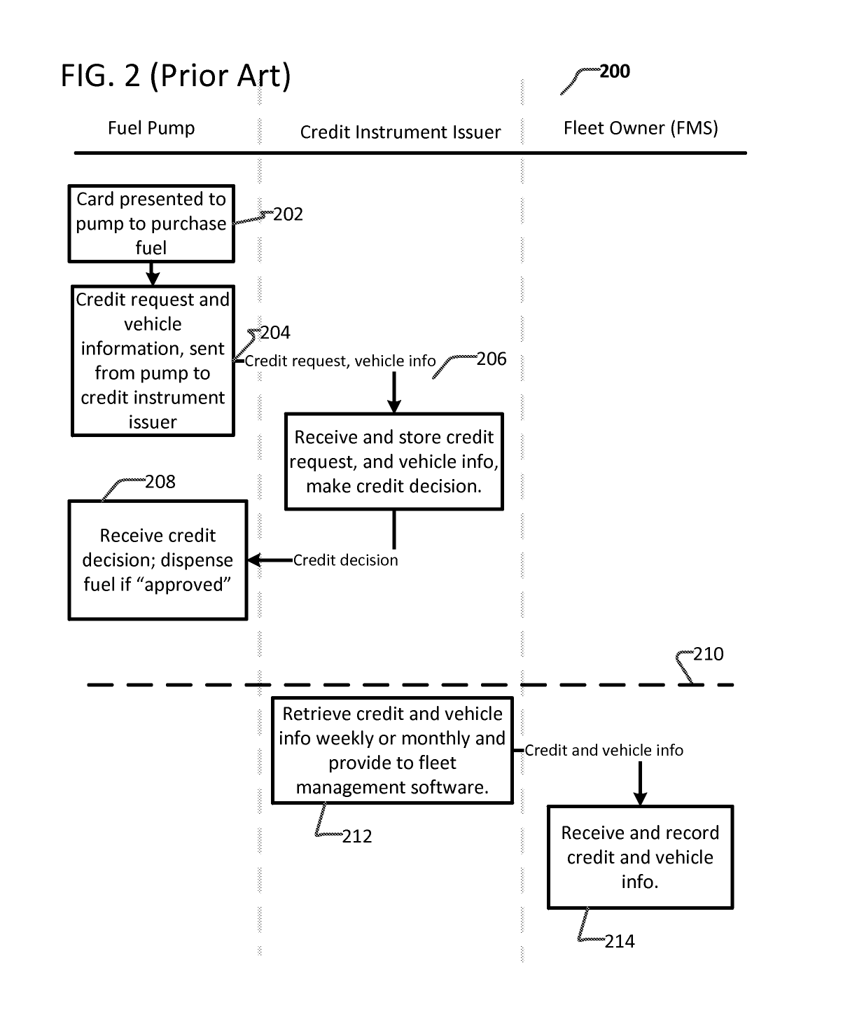

FIG. 2 is a flowchart depicting a prior art method 200 for fuel dispensing.

Method 200 begins at 202 where a credit instrument is presented to a pump to purchase fuel.

At 204 a credit request and vehicle information may be sent from fuel pump 24 to credit instrument issuer 12. The credit request may include information to identify credit instrument 28, a requested authorization amount, a PIN, and other information that may be read from credit instrument 28 by credit instrument reader 26.

As will appreciated by those of skill in the art, each credit instrument 28 may have a profile that is set up, for example by credit instrument issuer 12, partner/FMS Owner, and/or fleet owner 30. The profile may specify the information that fuel pump 24 will prompt the user of credit instrument 28 (normally a driver of vehicle 22) to enter before requesting a credit check and fuel to be dispensed. Such information may include a PIN, vehicle 22 odometer reading, an employee identification number (of the driver), and other information. Such profile may vary between credit instruments 28 depending on the requirements of the parties involved.

At 206, the entered information is received by the credit instrument issuer 12. This information may be stored by the credit instrument issuer 12. Credit instrument issuer 12 then makes a credit decision—to confirm or deny dispensing of fuel by fuel pump 24. The process of making a confirm or deny decision, and the factors upon which the decision may be made, is known by those of skill in the art but exemplary rules (“Credit Decision Fuel Dispensing Rules”) are shown in Table 1 herein.

TABLE 1
Credit Decision Fuel Dispensing Rules

| Rule | |
|---|---|
| No. | Affirm/confirm dispensing if: |
| 1. | Credit instrument's credit limit has not been reached. |
| 2. | Owner of credit instrument has been making timely payments. |

This decision is communicated back to, and received by, fuel pump 24 at 208. At 208 fuel is dispensed if the credit decision was a confirmation.

Dashed line 210 indicates the passage of time—the amount of time depending on the profile of credit instrument 28 as established above or as determined by fleet owner 30—often up to 31 days from the date of the transaction. After the passage of time, at 212, credit and vehicle information are provided to FMS 32. This may be done via downloading of transaction data for example. At 214 fleet owner 30, generally using FMS 32, obtains and stores the credit and vehicle information relating to the transactions for one or more credit instruments 28 and/or vehicles 22 in their fleet. This information can then be used to perform historical analysis of fleet performance.

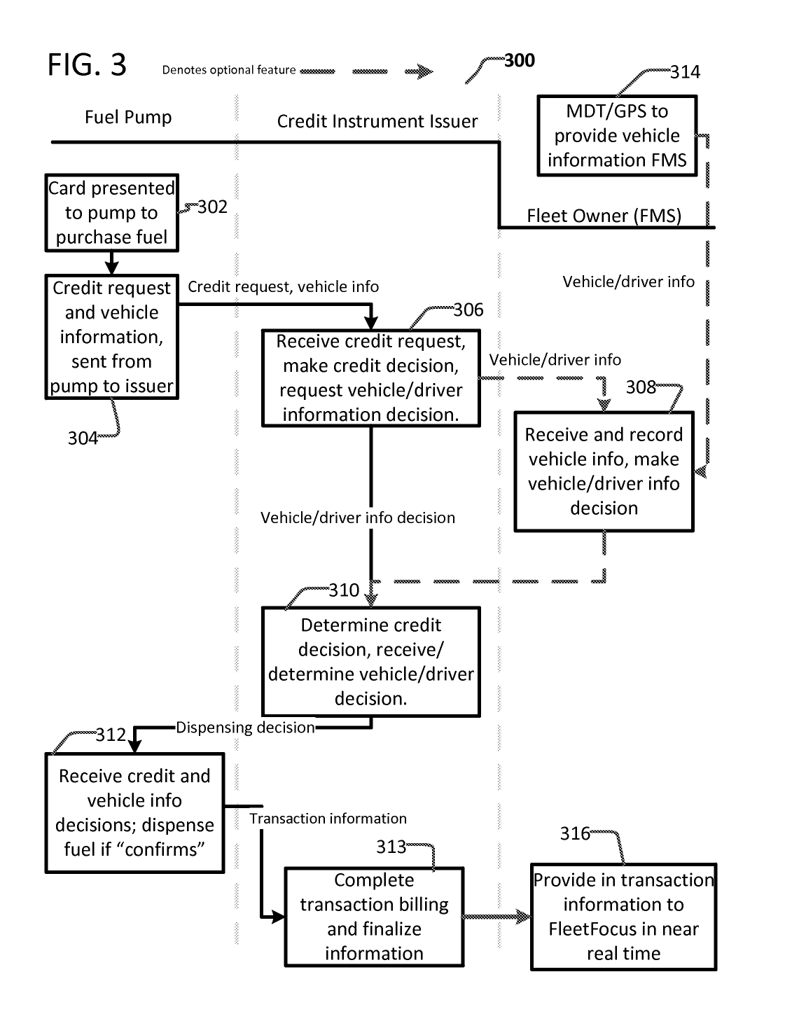

FIG. 3 is a flowchart depicting a method 300 for fuel dispensing according to a non-limiting embodiment of the present invention.

Method 300, at 302 and 304 may be substantially similar to method 200 at 202 and 204.

Once at 306 credit instrument issuer 12 may begin to make a credit decision. Making a credit decision may involve ensuring that credit decision fuel dispensing rules (such as in Table 1) are followed or complied with in order to authorize or confirm fuel dispensing from a credit decision perspective. These rules may be established by credit instrument issuer 12, possibly in conjunction with fleet owner 30. Such rules are preferably stored at, and checked for compliance, by credit instrument issuer.

Also at 306, credit instrument issuer 12 may send vehicle information to fleet owner 30 (via FMS 32), in real-time or near real-time (such as before fuel is dispensed or fuel dispensing is declined by fuel pump 24), for example to enable making a vehicle information dispensing decision and other business decisions.

Such other business decisions or issues may be made or addressed in real-time or near real-time, and in any event, much more quickly than prior art approaches where such information was only initially obtained occasionally for example, or as fleet owner 30 updates FMS 32 with data from credit instrument issuer 12 (such as credit instrument issuer's 12 website). Business decisions or issues that may be more effectively and/or accurately made include: contacting a driver to let them know they are in violation of a rule and ensure they rectify the situation before proceeding their vehicle use (and before further errors or damage can be caused), adjusting vehicle/driver/fuel statistics to account for errors made before they are included in any reports, ensuring that fuel pump 24 that is owned by fleet owner 30 is used by driver for the next fuelling and/or checks to ensure that appropriate fuel levels are present the next time vehicle 22 is fuelled at a fuel pump 24 owned by fleet owner 30. Of course many other business decisions and uses are within the scope of the present invention, including anti-fraud measures, driver training, cash management, and the like. Where a business rule or issue relates to a driver, the system may prevent unauthorized driver actions.

In some embodiments of the present invention, 308 and 314 may not be required, and all that may be required is for FMS 32 to receive the information and for credit instrument issuer 12 to make a credit decision and communicate that to fuel pump 24.

Method 300 may continue to 308 where vehicle and/or driver information is received by fleet owner 30 (such as via FMS 32) in near realtime. Vehicle and driver information provided to FMS 32 at 308 may include some or all of the information that the driver was prompted to provide in 304 and may include additional information as well, such as from previous transactions for credit instrument 12 or vehicle 22. FMS 32 may include one or more databases 34 that may be used to store, among other things, the vehicle and/or driver information received at 308.

The information may be communicated to FMS 32 via web services, application programming interfaces (API) or the like. Security and authorization may be implemented, as known to those of skill in the art. Web services, as known to those of skill in the art, provide a standard means of interoperating between different software applications, running on a variety of platforms and/or frameworks—in this case FMS 32 and credit instrument issuer 12 for example. The architecture does not attempt to specify how Web services are implemented, and imposes no restriction on how Web services might be combined, thus allowing flexibility for design and a useful interoperability architecture.

FMS 32, at 308, may compare the information received from credit instrument issuer 12 to various rules to decide whether to provide a “confirm” or “deny” vehicle information decision, such as rules relating to drivers (“Driver Information Fuel Dispending Rules”) and vehicles (“Vehicle Information Fuel Dispending Rules”). Any number and combination of rules is possible, depending on the business decisions of fleet owner 30, for example.

These rules may be established by fleet owner 30, possibly in conjunction with credit instrument issuer 12. Such rules are preferably stored at, and checked for compliance, by fleet owner 30 (via FMS 32). Alternatively of course, these rules may be stored at, and checked for compliance by credit instrument issuer 12. There may be integration between FMS 32 to alert credit instrument issuer 12 of any changes as FMS 32 is system of record. Where confirming such rules relies on obtaining information from MDT 23 FMS 32 may obtain such information and relay it to credit instrument issuer 12 or MDT 23 may communicate directly with credit instrument issuer 12.

Exemplary Driver Information Fuel Dispensing Rules are shown in Table 2.

TABLE 2
Driver Information Fuel Dispensing Rules

| Rule | |
|---|---|
| No. | Affirm/confirm dispensing if: |
| 1. | The provided driver identification number is not allowed to |
| | purchase fuel for the provided vehicle identification number. |
| 2. | Is the provided driver identification number allowed to |
| | purchase fuel using the credit instrument? |
| 3. | Location of driver and/or fuel pump is approved. |

TABLE 3
Vehicle Information Fuel Dispensing Rules

| Rule | |
|---|---|
| No. | Affirm/confirm dispensing if: |
| 1. | Is the provided odometer reading acceptable for |
| | fuel dispensing: |
| | Based on the last odometer reading received from credit |
| | instrument issuer? |
| | Based on the odometer reading received from the MDT? |
| | Noting that being acceptable, or accurate, may occur if the |
| | values are within an acceptable range. Such range may |
| | be 10 km, 100 km, or a value based on |
| | the driver/vehicle/fuel type/etc involved. |
| 2. | Is the requested authorization amount acceptable: |
| | Based on the odometer reading received from credit |
| | instrument issuer? |
| | Based on the odometer reading received from the MDT? |
| | Based on the size of the vehicle's gas tank? |
| | Based on the cost per liter of the fuel to be purchased? |
| 3. | Location of vehicle and/or fuel pump is approved. |
| 4. | Type of fuel selected is approved. |

Having assessed or confirmed the rules at 308, vehicle and driver information decisions are provided back to credit instrument issuer 12. This may include a confirmation or denial, or a set of confirmations and/or denials (for example to indicate which rule was not confirmed and thus provide a reason for a denial).

Method 300 then arrives at 310 (either directly from 306, or via 308/314, as described herein) where the overall decision to dispense fuel to vehicle 22 at fuel pump 24 is made and then communicated to fuel pump 24. The overall decision to dispense fuel may be based on each applicable rule being confirmed or complied with, for example, including credit, driver and vehicle rules.

At 312 fuel pump 12 dispenses fuel if the credit decision and vehicle/driver decision were all confirms, accepted or authorized.

Once the transaction has completed at 312 then transaction information may be provided to credit instrument issuer 12 at 313. Such transaction information may include an amount of fuel dispensed, a cost therefore, a date, location, and other transaction information. Transaction information provided from fuel pump 12 at 312 may be combined with information provided at 304, and other information, for example that credit instrument issuer 12 already has, and may be added to databases 14.

At 316 FMS 32, may compare the information received from credit instrument issuer 12 in near realtime to various rules (such as any of those described herein) to decide whether to flag vehicles for further investigation due to such as rules relating to drivers (“Driver Information Fuel Dispending Rules”) and vehicles (“Vehicle Information Fuel Dispending Rules”). Any number and combination of rules is possible, depending on the business decisions of fleet owner 30, for example. A wide variety of reports, dashboards and alerts will help client manage this from FMS 32.

Method 300 may optionally further include 314, where MDT 23 provides vehicle and/or driver information or vehicle location (such as via GPS, not shown). Such vehicle and/or driver information may be used to confirm one or more items of data that was received by credit instrument issuer 12 at 306 and/or 316. This may then allow further rules to be used, involving confirming data from vehicle 22 in real-time (such as confirming that the driver identifier entered at 304 is the same as the driver currently operating vehicle 22 and logged into MDT 23, or that the odometer value entered at 304 is the same as the odometer value read by MDT 23 from the odometer on vehicle 22. Whether 314 is used may depend on the rules that are available or activated, as determined by one or more of credit instrument issuer 12 or fleet owner 30, for example.

It will be understood that any of the systems or entities that are part of system 10 may have one or more computing devices, such as servers, mobile devices, personal computers and the like, and required network technology, configured to allow the performance of the functionality described herein. Each of such systems or entities, and such computing devices, may have one or more computer-readable storage medium, that may be transitory or non-transitory, that may contain a set of programming instructions that may be executed by the computing devices.

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

1. A method for facilitating the purchase of fuel from a fuel pump, by a driver using a credit instrument to make a request for fuel, for a vehicle forming part of a fleet of vehicles owned by a fleet owner, comprising:
prompting the driver to submit vehicle information and driver information via the fuel pump, responsive to a credit request to purchase fuel for a vehicle using the credit instrument;
determining whether the credit instrument has the required credit;
confirming the vehicle information and the driver information; and
if the credit instrument has the required credit and the vehicle and driver information is confirmed:
authorizing the dispensing of fuel by the fuel pump;
if the credit instrument has insufficient credit or one or both of the vehicle information and the driver information cannot be confirmed:
declining the dispensing of fuel by the fuel pump.

2. The method of claim 1 wherein the vehicle information comprises a vehicle identifier and an odometer value and the driver information comprises a driver identifier.

3. The method of claim 2 wherein the confirming further comprises:
checking whether one or more vehicle information fuel dispensing rules have been complied with; and
ascertaining whether one or more driver information fuel dispensing rules have been complied with.

4. The method of claim 3 wherein the vehicle information dispensing rules comprise:
the odometer value for the vehicle is sufficiently higher than an odometer reading at a last request for fuel for the vehicle.

5. The method of claim 4 wherein the vehicle information dispensing rules further comprise:
the odometer value is accurate.

6. The method of claim 6 wherein the odometer value is accurate if it is within an acceptable range of an odometer reading from the vehicle.

7. The method of claim 3 wherein confirming further comprises receiving one or more of an odometer reading and the odometer reading at a last request for fuel for the vehicle.

8. The method of claim 7 wherein the receiving is from fleet management software, and wherein the fleet management software is configured to communicate vehicle information with the vehicle and to store the vehicle information.

9. The method of claim 3 wherein the driver information dispensing rules comprise:
the driver identifier is authorized to fuel the vehicle; and
the driver identifier is authorized to use the credit instrument.

10. The method of claim 1 further comprising, after the step of authorizing the dispensing of fuel by the fuel pump:
obtaining, from the fuel pump, transaction information; and
providing the transaction information to the fleet management software.

11. A system for making a decision to dispense fuel from a fuel pump, responsive to a vehicle driver desiring to purchase fuel for a vehicle using a credit instrument owned by a vehicle owner, the system comprising:
a credit instrument, configured to cause a fuel pump to receive and communicate purchase parameters and a first set of vehicle information to a credit instrument issuer system, before seeking a credit decision and a fuel dispensing decision; and
a credit instrument issuer system, configured to receive the purchase parameters and the first set of vehicle information from the fuel pump, make a credit decision and a fuel dispensing decision based on at least the purchase parameters or the first set of vehicle information, provide the credit decision and the fuel dispensing decision to the fuel pump, and record a transaction information received from the fuel pump.

12. The system of claim 11 wherein the credit instrument is a credit card, the purchase parameters include a date, a credit card number and a driver identifier of the vehicle driver and the first set of vehicle information comprises a vehicle number and a current odometer value from the vehicle.

13. The system of claim 12 wherein the credit instrument issuer system further comprises a rules storage, where the rules storage is configured to store credit decision rules and fuel dispensing rules for the credit instrument and the fuel dispensing decision is affirmative if all credit decision rules and fuel dispensing rules are adhered to for the credit card.

14. The system of claim 13 wherein the credit decision rules for the credit card comprise:
the vehicle driver is permitted to use the credit card, to purchase fuel for the vehicle; and
the credit card has a balance that is below an acceptable balance.

15. The system of claim 13 wherein the fuel dispensing rules for the credit card comprise:
the vehicle driver is permitted to use the credit card, to purchase fuel for the vehicle;

16. The system of claim 11 further comprising:
a fleet owner configured to receive the transaction information from the credit instrument issuer system via a fleet management system.

17. The system of claim 16 wherein the fleet owner is further configured to prevent unauthorized driver actions via the fleet management system.

18. A method for facilitating the purchase of fuel from a fuel pump, by a driver using a credit instrument to make a request for fuel, for a vehicle forming part of a fleet of vehicles owned by a fleet owner, comprising:
receiving, from a credit instrument issuer, vehicle information and driver information, obtained from a driver that was prompted to submit vehicle information and driver information via the fuel pump, responsive to a credit request to purchase fuel for a vehicle using the credit instrument; and
confirming the vehicle information and the driver information; and
if the credit instrument has the required credit and the vehicle and driver information is confirmed:
authorizing the dispensing of fuel by the fuel pump;
if the credit instrument has insufficient credit or one or both of the vehicle information and the driver information cannot be confirmed:
declining the dispensing of fuel by the fuel pump.

19. The method of claim 18 wherein the vehicle information comprises a vehicle identifier and an odometer value and the driver information comprises a driver identifier.

20. The method of claim 19 wherein the confirming further comprises:
checking whether one or more vehicle information fuel dispensing rules have been complied with; and
ascertaining whether one or more driver information fuel dispensing rules have been complied with.

21. The method of claim 20 wherein the vehicle information dispensing rules comprise:
the odometer value for the vehicle is sufficiently higher than an odometer reading at a last request for fuel for the vehicle.

22. The method of claim 21 wherein the vehicle information dispensing rules further comprise:
the odometer value is accurate.

23. The method of claim 22 wherein the odometer value is accurate if it is within an acceptable range of an odometer reading from the vehicle.

24. The method of claim 21 wherein the driver information dispensing rules comprise:
the driver identifier is authorized to fuel the vehicle; and
the driver identifier is authorized to use the credit instrument.

25. The method of claim 18 further comprising:
if the confirming is affirmed:
receiving, from the credit instrument issuer, a transaction information relating to the purchase of fuel from the fuel pump.

26. The system of claim 25 wherein the fleet management system is further configured to:
if the confirming is affirmed:
allowing a fleet owner to prevent unauthorized driver actions.

27.-36. (canceled)
